(19) United States
(12) Patent Application Publication
(10) Pub. No.: US 2024/0354237 A1
(43) Pub. Date: Oct. 24, 2024

(54) SYSTEM AND METHOD FOR TESTING DIFFERENT COMPONENTS USING DIFFERENT TEST CASES

(71) Applicant: Dr. Ing. h.c. F. Porsche Aktiengesellschaft, Stuttgart (DE)

(72) Inventors: Maximilian Rabus, Stuttgart (DE); Raphael Romeikat, Berlin (DE); Daniel Oberfranke, Leonberg (DE); Tim Bosler, Winnenden (DE); Aleksandr Negreev, Berlin (DE); Konstantin Mueller, Berlin (DE)

(21) Appl. No.: 18/636,848

(22) Filed: Apr. 16, 2024

(30) Foreign Application Priority Data
Apr. 19, 2023 (DE) 10 2023 109 886.1

(51) Int. Cl. G06F 11/36

(52) U.S. Cl. CPC G06F 11/3684

(57) ABSTRACT

A system for testing different components using different test cases has a first user interface (12) for inputting component attributes across components and test attributes across test cases. Each component is defined by plurality component attributes across components and each test case is defined by plural test attributes across test cases. A computer-based test tool (30) has a test plan module (40), in which a test case-specific and component-specific test plan can be determined in each case from plural component attributes across components and a plurality test attributes across test cases. A second user interface (16) is provided for outputting a test-specific and component-specific test plan.

### CROSS-REFERENCE TO RELATED APPLICATION

This application claims priority on German Patent Application No 10 2023 109 886.1 filed Apr. 19, 2023, the entire disclosure of which is incorporated herein by reference.

### BACKGROUND

Field of the Invention. The invention relates to a system for testing different components using different test cases. In addition, the invention relates to a method for operating the system to test different components using different test cases.

Related Art. The development of motor vehicles requires many components to be tested to ensure proper functioning of the components. A component may be a component of the motor vehicle, for example the internal combustion engine, or the entire vehicle itself. The components can be released only if certain conditions have been met and checked in various tests, and some of these conditions may be required by law. Such tests include crash tests of a motor vehicle. To perform such tests, a vehicle-specific and test case-specific plan must be created for each combination of a motor vehicle model and a test case. The test plan defines all vehicle-specific and test-specific conditions to be able to perform the test properly. In the exemplary crash tests mentioned above, the vehicle-specific conditions comprise different configurations of the vehicle model, for example whether an internal combustion engine with an associated tank or an electric traction engine with an associated battery is present, whether a second row of seats is present, or how many vehicle doors are present. The test-specific conditions for the crash test include, for example, the test boundary conditions, such as the target start speed or the target tank filling in a motor vehicle that has an internal combustion engine and a fuel tank, and the barrier properties to be present in the predefined test, such as the position of the barrier or the material property of the barrier.

The test-specific and component-specific test plan typically is created manually, with the developers using their experience to define all of the vehicle-specific and test case-specific conditions required for each individual test case, thereby creating a test order. In a subsequent step, the tests typically are performed by at least one other person, in particular by a test person specialized in testing components, based on the test order submitted to the test person. After the test has been performed, the test person typically transmits the measurement data to at least one other person who performs a completeness and plausibility test of the measurement data. Finally, the person who created the test order typically receives the measurement data. The measurement data then is evaluated and corresponding documentation of the tests is created.

A disadvantage of this approach is that manual creation of the test order is very time-consuming because plural parameters must be specified manually by a person. The information is exchanged between people via data packets that are transmitted in different ways. As a result, the same data packets exist on different servers and take up a large amount memory space due to the large amount of complex information.

An objective of the invention is to provide a system for testing different components by different test cases, with which test-specific and component-specific test plans can be performed in a time-saving and resource-saving manner.

### SUMMARY OF THE INVENTION

The system comprises a first user interface that is used to input component attributes for plural components (often many components) and test attributes for plural tests (often many tests).

The attributes across the plural components may be features that are common to different vehicle models. Different vehicle models may have versions with an internal combustion engine or with an electric drive device. Different vehicle models also could have versions with a single row of seats or two rows of seats or versions with two doors versus four doors. The decisive factor is that the attributes that describe the components lead to different consequences for certain tests. For example, in a crash test with a motor vehicle with a second row of seats, the deformation behavior can be completely different from that of a motor vehicle with a single row of seats. This attribute is across components as different vehicle models may be equipped with a single or multiple rows of seats. The deformation behavior also can vary depending on whether the vehicle has two doors or four doors. Existing components with the corresponding component attributes may be selected. For example, a specification of a motor vehicle that has already been created, defined and saved by multiple component attributes, can be selected so that the component attributes across components do need not to be selected individually.

The attributes across tests are features that are relevant for different test cases and may only change in amount. For example, there are different test cases to determine the crash safety. More particularly, the test can simulate a small overlap crash, a side impact or a parking collision. In all test cases, for example, the start speed is relevant as a test attribute across test cases, and the level of the speed can vary. Here too, it is preferable to select existing test cases with the corresponding test attributes.

By selecting the component attributes across components and the test attributes across tests, each individual component and each individual test case can be defined clearly, so that a test-specific and component-specific test plan is available if the component attributes across components and the test attributes across tests are selected. The determination of the test case-specific and component-specific test plan is performed by a computer-based test tool that may be cloud-based. The test plan contains only information that is required to perform a test case defined by plural test-specific test attributes for a vehicle model defined by multiple component attributes across components.

This means a test order or test-specific and component-specific test plan can be created by simply selecting the component attributes across components and the test attributes across tests. The person creating the test plan can select existing attributes. Additional attributes also may be added by the appropriate person with a corresponding authorization.

The system further comprises a second user interface to output a test-specific and component-specific test plan. In this way, the person performing the test may retrieve the test plan via the second user interface. The resulting test plan contains all information necessary to perform the test. This creates a system through which the person giving the test order can transmit the information required to perform the test to the test person in a simple and clear manner.

In some embodiments, the computer-based test tool has a measurement point module that is configured to determine the measurement points as a function of the test case-specific and component-specific test plan. A variety of options exist, i.e., measurement points across test cases and components, to capture certain functions of the tested components. For example, the person performing the test may place measurement devices at the measurement points identified in the test plan, and the test results determined by the measurement devices at the respective measurement points may be transmitted (e.g. wirelessly) to the second user interface. The second user interface then can transmit the test result to the computer-based test tool. Accordingly, the measurement point module determines the test-specific and component-specific measurement points from the measurement points across components and across test cases. Thus, the test order or test plan contains only the measurement points that are actually useful for the specific test case and the specific component.

The computer-based test tool of some embodiments has a test documentation module that is configured to create test documentation as a function of the test case-specific and component-specific test plan. A variety of test documentation options exist. The test documentation module creates a test documentation that contains only the information that is meaningful and useful for a specific test case on a specific component. The test documentation module is configured such that corresponding information on the test documentation is compiled automatically depending on the combination of test case and the tested component.

The invention also relates to a method for testing components by means of the above-described system. In accordance with the method, component attributes across components and test attributes across test cases are input via the first user interface. A test case-specific and component-specific test plan then is created based on the input. The test case-specific and component-specific test plan is retrieved via the second interface and the component is tested based on the test case-specific and component-specific test plan. The test results of the performed test are provided via the second user interface for retrieval via the first user interface.

An embodiment of the invention is explained in further detail with reference to the drawing.

### BRIEF DESCRIPTION OF THE DRAWINGS

FIG. 1 schematically shows a system for testing different components using different test cases.

### DETAILED DESCRIPTION

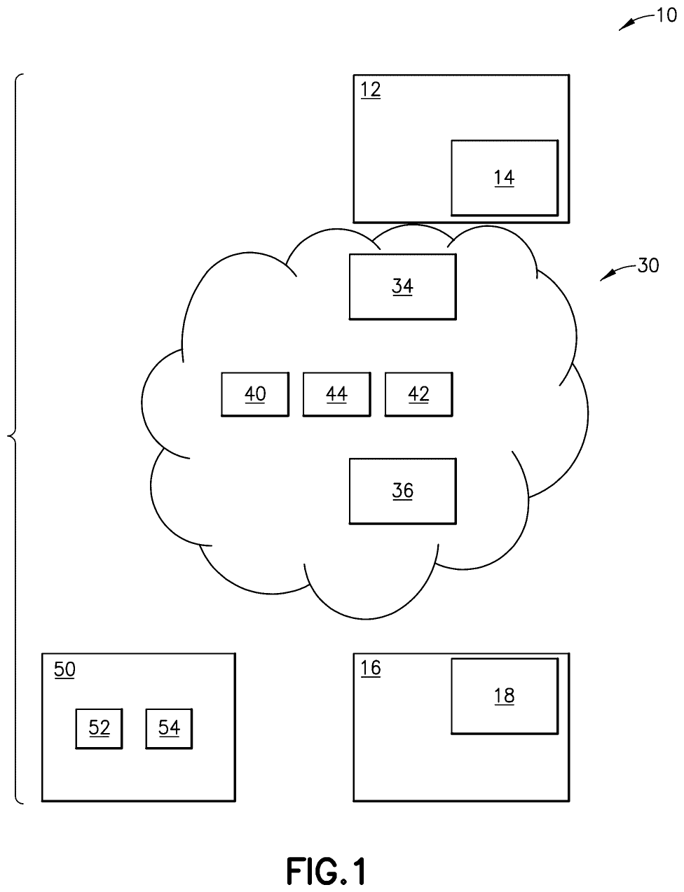

FIG. 1 schematically shows a system 10 for communicating between a person instructing a test and a person performing the test.

The system 10 comprises a first user interface 12, a second user interface 16, and a cloud-based computer-implemented test tool 30.

The first user interface 12 is bi-directional and comprises a communication module 14. The communication module 14 is bi-directionally and wirelessly connected to a corresponding counter-communication module 34 of the test tool 30 such that first user interface 12 serves as an input and output interface for information. The person instructing the test may transmit or receive information via the first user interface 12.

The second user interface 16 is also bi-directional and comprises a communication module 18. The communication module 18 is bi-directionally and wirelessly connected to a corresponding counter-communication module 36 of the test tool 30. Thus, the second user interface 16 also serves as an input and output interface for information. The person performing the test may transmit or receive information via the second user interface 16.

The two bi-directional user interfaces 12, 16 allow information to be passed in both directions.

The cloud-based computer-implemented test tool 30 may be understood in connection with this disclosure to include a machine or electronic circuitry or a high-performance computer, for example. In particular, the cloud-based computer-implemented test tool 30 may comprise a master processor (central processing unit (CPU)), a microprocessor, or a microcontroller, for example an application-specific integrated circuit or a digital signal processor, optionally in combination with a memory unit for storing program instructions, as well as storing component attributes across components and the test attributes across tests. The computer-implemented test tool may also be understood to mean or comprise a virtualized processor, a virtual machine, or a soft CPU. For example, the computer-implemented test tool may also be a programmable processor equipped with configuration steps for carrying out the method described herein or configured with configuration steps in such a way that the programmable processor realizes the features of the method and system described herein. In addition, highly parallel computing units and high-performance graphics modules may be provided. A “memory unit” or “memory module” and the like may, for example, be understood in connection with this disclosure to mean a non-volatile memory in the form of a flash memory (Flash EEPROM) or a permanent memory, such as a hard drive. The cloud-based test tool 30 comprises a test plan module 40, a measurement point module 42, and a test documentation module 44. The test plan module 40 functions to create a test plan and includes a memory for storing component attributes across components and the test attributes across tests. The measurement point module 42 functions to determine the test points as a function of the test plan created by the test plan module 40. The test points, for example, may be locations on a motor vehicle 50. Measurement devices 52, 54 are placed on the component (e.g. on the motor vehicle 50) and communicate (e.g. wirelessly) with the at least one of the communication modules 18, 36. The test documentation module 44 is used to create documentation of the test performed as a function of the test plan created by the test plan module 40.

The determination of a test plan is based on the plural component attributes across plural components and plural test attributes across tests that are stored or can be stored in the test plan module 40. On the one hand, each component may be uniquely defined by specifying plural component attributes across components. On the other hand, each test case can be defined clearly by specifying several test attributes across test cases. A test case-specific and component-specific test plan is determined or created by the test plan module 40 based on the input of the component attributes across components and the test attributes across test cases.

Based on the test case-specific and component-specific test plan, the measurement point module 42 determines the measurement points and determines which are meaningful and useful for the specific test case and the specific component according to the test plan. In addition, the test attributes across tests defined for the test case are populated automatically with corresponding values.

The person performing the test uses the second user interface 16 to retrieve the test case-specific and component-specific test plan and the measurement points based thereon. All of the information required to perform the test case-specific and component-specific test is included in the test plan. The test plan thus forms a so-called test order. The test then is performed based on the test case-specific and component-specific test plan. The results of the test performed are transmitted to the test tool 30 via the second user interface 16 and may be evaluated and documented in the test tool 30. The test documentation module 44 functions to ensure that the documentation is carried out as a function of the test case-specific and component-specific test plan. Only the information required for the specific test case of the specific component is compiled in the documentation.

In the following sections, the system will again be described as an example on a crash test of different vehicle models. Here, the motor vehicle models are the components to be tested, and the different crash cases are the different test cases. In a first step, the component attributes across components, i.e., the attributes across vehicle models, and the test attributes across test cases are entered via the first user interface. Such attributes across vehicle models include, for example, whether an internal combustion engine is installed, whether a second row of seats is present, or whether the vehicle model is a four-door or two-door model. Other attributes across vehicle models that are relevant for the different test cases, i.e., for the different crash tests or crash cases, also can be entered. For example, test attributes across test cases in crash tests are the target start speed or barrier properties.

It is decisive that all information for performing the test is available by specifying the component attributes across components corresponding to the vehicle model to be tested and the test attributes across test cases corresponding to the test case to be tested. Here, a test case-specific and component-specific test plan is created by the test plan module 40 from the entered component attributes across components and the entered test attributes across test cases. In addition, the measurement points required for the test case are determined by the measurement point module 42. In the crash test, such measurement points are, for example, the steering column displacement or the rear left door pressure measurement in a four-door vehicle model.

The test plan created and the associated measurement points form a test order for a crash test can be retrieved by the person performing the crash test via the second user interface 16. The person performing the crash test then performs the test and transmits measurement results back to the test tool 30 via the second user interface 16. The measurement results are stored in a memory of the test tool 30 and may be retrieved by the person who issues the test order. In addition, documentation of the measurement results is created by the test documentation module 44 as a function of the test case-specific and component-specific test plan, which can also be retrieved. The documentation only contains information that is actually meaningful and useful for the crash test performed.

This creates a system 10 that simplifies the communication between the person instructing the test and the person performing the test.

1. A system for testing different components for motor vehicles, the system comprising:
a computer-based test tool (30) that includes a test plan module (40) with a memory that stores a plurality of component attributes and a plurality of test attributes, the test plan module (40) being configured for determining a test-specific and component-specific test plan from the stored component attributes and the stored test attributes;
a first user interface (12) communicating with the teat plan module (40) and inputting to the test plan module (40) at least one component attribute from the stored component attributes and at least one test attribute from the plurality of test attributes;
a second user interface (16) communicating with the teat plan module (40) for outputting a test-specific and component-specific test plan determined by the test plan module (40) based on the at least one component attribute and the at least one test attribute input to the test plan module (40) by the first user interface (12).

2. The system of claim 1, wherein the computer-based test tool (30) further comprises a measurement point module (42) that is configured to determine measurement points for the test-specific and component-specific test plan.

3. The system of claim 2, further comprising measuring devices (50, 52) removably positionable on the components at the measurement points, the measuring devices communicating wirelessly with the second user interface (16).

4. The system of claim 1, wherein the computer-based test tool (30) comprises a test documentation module (44) that is configured such that test documentation is created as a function of the test-specific and component-specific test plan.

5. The system of claim 1, wherein the computer-based test tool (30) is cloud-based.

6. A method for testing components, comprising:
entering component attributes across components and test attributes across test cases via a first user interface (12);
identifying measurement points based on the entered component attributes and the entered test attributes;
creating a test-specific and component-specific test plan based on the entered component attributes and the entered test attributes;
retrieving the test-specific and component-specific test plan via a second user interface (16);
testing the component with measurement devices placed at the identified measurement points based on the test-specific and component-specific test plan; and
providing the test results via the second user interface (16) for retrieval via the first user interface (12).

7. The method of claim 6, further comprising placing measurement devices at the identified measurement points and transmitting measurement data from the measurement devices to the second user interface (16).
